(19) United States
(12) Patent Application Publication
(10) Pub. No.: US 2004/0036188 A1
(43) Pub. Date: Feb. 26, 2004

(54) Recoating of optical fiber

(76) Inventors: Esteban Arboix, (US); Ion Dumitriu, Osmo (SE)

Correspondence Address: NIXON & VANDERHYE, PC, 1100 N GLEBE ROAD, 8TH FLOOR, ARLINGTON, VA, 22201-4714, US

(21) Appl. No.: 10/362,021

(22) PCT Filed: Aug. 10, 2001
(86) PCT No.: PCT/SE01/01732

(30) Foreign Application Priority Data
Aug. 17, 2000 (SE) 0002935-5

(51) Int. Cl. B29D 11/00

(52) U.S. Cl. 264/1.27; 425/116; 425/129.1; 425/174.4

(57) ABSTRACT

An apparatus (1) for recoating uncoated and spliced end portions of optical fibers (17) comprises two mold blocks (21a, 22b), each of which includes a groove (22a, 22b), the mold blocks being arrangable in a closed state, wherein the grooves cooperate to form a mold cavity for the fiber end portions, and in an open state, wherein the fiber end portions are insertable into the grooves. The apparatus further includes an injection system (5) for injecting a recoating material into the mold cavity, and a UV curing system (6) for irradiating the recoating material with UV light, thus curing the recoating material. At least one mold block is made of a plastic material comprising a fluoroplastic, e.g. PCTFE, the plastic material being at least partly transparent to UV light to enable the curing system to irradiate the UV curable recoating material with UV light through this mold block.

### TECHNICAL FIELD OF THE INVENTION

The present invention generally relates to fiber optics. More specifically, the invention relates to an apparatus and method for recoating uncoated and spliced end portions of optical fibers.

### DESCRIPTION OF RELATED ART AND BACKGROUND OF THE INVENTION

The use of optical communications involving the use of optical fibers has increased at an exceptional pace. The main reasons to this are the large transmission capacity of optical fibers; the large distances over which information can be transferred without need of repeaters (around 70 km for optical fiber cables as compared to 2 km for electrical transmission); and the immunity to interferences. Further, the optical fibers are cheap to produce, have low weight, and have small diameters.

Typically, an optical fiber has a diameter on the order of 125 microns, and is covered with a dual protective coating, which increases the outer diameter of the coated fiber to about 250 microns. The coating comprises typically an inner, relatively soft acrylate coating to protect the fiber against attenuation derived from microbending, and an outer, relatively harder acrylate coating for protection against external abrasion and for giving mechanical protection to the fiber. The layers also protect the fiber against external environmental hazards such as moisture and chemicals.

Optical cables-may comprise a plurality of these optical fibers which are bundled together or which are assembled in planar arrays, which are referred to as ribbons.

The technology for forming low-loss optical fibers has advanced to a point where there is widespread commercial manufacturing of optical fibers. Most processing includes drawing an optical fiber from a previously manufactured glass boule, sometimes referred to as a fiber preform. After it has been drawn, the optical fiber is usually provided with the protective coating material, which may be cooled or cured by any suitable technique for achieving solidification.

Further, extremely long lengths of fiber may be obtained by splicing a plurality of lengths, which are obtained using current manufacturing techniques. Additionally, it has become increasingly more common to splice optical fibers, which have broken, either accidentally, or during appropriate proof testing. For these and other applications, splicing in which the coating material is removed from end portions of two fibers, which are then fused together end to end, provides a suitable means for joining the ends of two glass fibers with an acceptably low loss. Then, the spliced end portions are recoated to fulfill requirements on dimensional and strength parameters associated with the coated fiber.

A grooved split mold apparatus for recoating spliced end portions of optical fibers is disclosed in U.S. Pat. No. 4,976,596 which issued on Dec. 11, 1990 in the name of Darsey et al., said mold being made of a UV transparent material such as Plexiglas® or quartz. The recoating involves placing the spliced fiber end portions, from which the original coating material has been removed in such a manner as to leave a tapered portion remaining on the end portion of each optical fiber, within the groove of the split mold. Then, the mold is covered to enclose the groove and a suitable UV curable coating material, such as acrylate or epoxy, is injected into the groove to recoat the bared, spliced fiber end portions, whereafter the coating material is UV cured to yield a recoated splice section. The effective diameter of the groove is such that any overlap of some of the recoating material with original coating material on adjacent portions of the fibers being spliced is minimized. However, while such grooved split mold apparatus is made of Plexiglas® or quartz in order to be highly transparent to UV light to allow curing of the recoating material by passing UV radiation through the mold, such materials tend to be sticky with respect to the UV curable coating material (acrylate or epoxy). Thus it may be difficult to remove the optical fiber subsequent to recoating and the recoating may be damaged while doing so.

Such problem may be solved by spraying a layer of a release agent or a non-stick material such as polytetrafluoroethylene (Teflon®) on the matching faces, i.e. within the groove, prior to inserting the fiber in the groove, as is disclosed in U.S. Pat. No. 4,954,152, which issued on Sep. 4, 1990 in the name of Hsu et al. The fiber to be coated is then placed into the groove, so that the uncoated region is near the longitudinal center of the groove. The unfilled volume of the groove is subsequently filled with a flowable, ultraviolet curable polymer that polymerizes to become the buffer coating. The polymer is cured by directing ultraviolet light of a wavelength appropriate to the polymer, preferably from a strong UV output mercury lamp, into the previously uncured polymer, through the transparent walls of the Plexiglas® mold.

Such solution is, however, not optimal since it involves an additional operation step in the recoating process, i.e. the spraying of Teflon® into the groove. Such operation is costly, time-consuming and difficult to implement, particularly in a fast and reliable automated recoating apparatus. Further, the amount of Teflon® sprayed into the groove has to be precisely controlled to avoid too thick layers of Teflon® as such layers would strongly absorb UV light and thus unfavorably affect the curing process.

Further, such sprayed Teflon® may also negatively affect the adhesion of the polymer recoating material to the bare glass fiber.

### SUMMARY OF THE INVENTION

It is a main object of the present invention to provide a mold apparatus and method for recoating uncoated and spliced end portions of optical fibers with a UV curable recoating material, which provide for a fast and high-quality recoating to a low cost.

It is in this respect a particular object of the invention to provide such apparatus and method, which provide for a simple and trouble-free removal of the recoated fiber end portions from the recoating apparatus subsequent to recoating and curing, while the curing time is kept to a minimum.

It is still a further object of the invention to provide such apparatus and method, which provide for long term use of the mold apparatus without any considerable degradation of the same.

It is yet a further object of the invention to provide such apparatus and method, which provide for a completely automated recoating.

These objects, among others, are according to a first aspect of the present invention attained by an apparatus comprising first and second mold blocks, each of which includes a longitudinally extending groove in a surface thereof, wherein the bottom and top mold blocks can mutually be placed in a closed clamped state, in which the longitudinally extending grooves cooperate to form a mold cavity for the optical fiber end portions, and in an open state, in which the optical fiber end portions are insertable into and removable from one of the longitudinally extending grooves. Further, the apparatus comprises an injection system for injecting a UV curable recoating material into the mold cavity, and a UV curing system for irradiating the UV curable recoating material injected into the mold cavity with UV light, thus curing the recoating material. At least one of the first and second mold blocks is made of a plastic material comprising a fluoroplastic, wherein the plastic material is at least partly transparent to UV light to enable the UV curing system to irradiate the UV curable recoating material injected into the mold cavity with UV light through that mold block.

The fluoroplastic-containing plastic material has advantageously a surface tension of less than 50 N/m, preferably less than 40 N/m, and more preferably less than 30 N/m. Examples of preferred fluoropolymers are PCTFE, FEP, PFA, PTFE (Teflon®), ETFE and ECTFE.

By such provisions an improved recoating apparatus is obtained. The inventors insight that a molding apparatus made of e.g. PCTFE, FEP, and PFA exhibits excellent performance regarding UV transparancy to the curing UV light and non-stickiness with respect to the UV curable molding material, e.g. acrylate, has lead to the present invention. The inventive recoating apparatus thus provides for fast and reliable recoating to a low cost. The non-stickiness of the recoating material provides for straightforward and unproblematic removal of the recoated fiber end portions subsequent to curing, and the high UV transparancy of the recoating material provides for short curing times. The lack of spray layers or other surface layers provides for long time use of the mold apparatus without any substantial degradation of the recoating apparatus or its operation.

Further, by providing a recess in the mold block made of a plastic material comprising a fluoroplastic arranged so as to reduce the distance the UV light from the UV curing system has to propagate through the partly UV transparent mold block before reaching the mold cavity, a still shorter curing time may be obtainable due to reduced UV light absorption by the mold block, while still a mold block of fairly large and thus handy size is provided. Alternatively, instead of reducing the curing time, the UV light intensity may be reduced.

Still further, by providing stretching means, preferably of an elastic material, for stretching and aligning the optical fiber end portions when the first and second mold blocks are arranged in the closed state, it is secured that the fiber is not curved within the mold cavity due to e.g. gravitation forces or fiber curl, and thus a uniform recoating is obtained with a longitudinally and circumferentially constant thickness. The stretching means are preferably implemented as a pair of elastic stretchers mounted on the first mold block and being inclined with respect to a plane perpendicular to the longitudinal axis of the mold cavity, and a pair of slide surfaces arranged in or adjacent the second mold block and extending parallel with the longitudinal axis of the mold cavity, the stretchers and grooves cooperating to stretch and align the optical fiber end portions when the first and second mold blocks are arranged in the closed state.

Yet further, by providing a pivotable clamping unit for moving the first and second mold blocks relative each other between the open and closed states, a simple and reliable movement mechanism is obtained, which allows for a practicable and ease access to one of the mold block grooves while the mold blocks is in the open state. Preferably, the mold blocks are arranged one on top of the other, in which case the top mold block may be moved by the pivotable clamping unit to allow insertion of the fiber end portions into the bottom mold block groove which is facing upwards.

The pivotable clamping unit is preferably a double acting pivotable clamping unit, preferably pneumatically driven, and has a pivoting stroke, in which the first and second mold blocks are pivoted relative each other, and a clamping stroke, in which the first and second mold blocks are clamped together to reach the closed state.

Finally, by providing a container for the UV curable recoating material, a peristaltic pump preferably driven by any of a controlled DC motor, a servo motor, and a stepping motor, particularly geared, a tubing system and an injection needle preferably opaque to the UV light and mounted within one of the mold blocks, for transporting the UV curable recoating material from the container to the mold cavity, an injection system for injection of the recoating material into the mold cavity, wherein the recoating material is contacting only the, container, the inner surfaces of the tubing and the needle, is obtained. Such container-tubing combination is preferably exchanged each time the recoating apparatus is used, and thus only the needle has to be cleaned regularly. By using a UV opaque injection needle it is secured that no or only a very small injection plug of the recoating is achieved.

By injecting a controlled amount of recoating material at a controlled velocity the length of the recoating and the appearance of the overlaps between the recoating and the original coatings may be controlled. For this purpose and for obtaining a fast injection the pump may be adapted to transport the UV curable recoating material at a first velocity during a first part of the injection, and at a second velocity during a latter part of the injection, the second velocity being substantially lower than the first velocity. In such manner a fast and at the same time precise injection of recoating material is obtained. Additionally, any wings on the recoated fiber due to high pressure during injection are avoided.

Furthermore, the above-mentioned objects, among others, are according to a second aspect of the present invention attained by a method comprising the following steps:

(i) arranging a first and a second mold block, respectively, each of which includes a longitudinally extending groove in a surface thereof and at least one of which is made of a plastic material comprising a fluoroplastic, preferably PCTFE, FEP, or PFA, the plastic material being at least partly transparent to UV light, in an open state, in which the optical fiber end portions are insertable into and removable from one of the longitudinally extending grooves;

(ii) inserting the optical fiber end portions into one of the longitudinally extending grooves;

(iii) arranging the first and second mold blocks in a closed clamped state, in which the longitudinally extending grooves cooperate to form a mold cavity for the optical fiber end portions;

(iv) injecting a UV curable recoating material into the mold cavity;

(v) irradiating the UV curable recoating material injected into the mold cavity with UV light, thus curing the recoating material, the irradiating comprises transmitting the UV light through the mold block made of a plastic material comprising a fluoroplastic;

(vi) arranging the first and second mold blocks in the open state; and

(vii) removing the optical fiber end portions from the one of the longitudinally extending grooves.

Further characteristics of the invention and advantages thereof will be evident from the following detailed description of embodiments of the invention.

### BRIEF DESCRIPTION OF THE DRAWINGS

The present invention will become better understood from the detailed description of embodiments of the present invention given hereinbelow and the accompanying FIGS. 1-6, which are given by way of illustration only, and thus are not limitative of the present invention.

FIG. 1 illustrates, schematically, in an exploded perspective view, an apparatus for recoating spliced end portions of two lengths of optical fibers according to the present invention.

FIG. 2 illustrates, schematically, in an enlarged exploded perspective view, the upper portions of the apparatus of FIG. 1.

FIG. 3 illustrates, schematically, in a perspective view, particularly a mold arrangement as being comprised in the apparatus of FIG. 1.

FIG. 4 illustrates, schematically, in a top view, the bottom mold of the mold arrangement of FIG. 3.

FIG. 5 illustrates, schematically, in a side elevation view, the mold arrangement of FIG. 3.

FIG. 6 illustrates, schematically, in an enlarged perspective view, the upper central portions of the apparatus of FIG. 1.

FIG. 7 illustrates, schematically, in an enlarged perspective view, the top mold of the mold arrangement of FIG. 3.

FIG. 8 illustrates, schematically, in a highly enlarged perspective view, portions of the bottom mold of FIG. 4.

FIGS. 9 and 10 illustrate, schematically, in a perspective view, the mold arrangement in an open and a closed state, respectively, wherein a stretching mechanism of the recoating apparatus is clearly visualized.

FIG. 11 illustrates, schematically, in a top view, the apparatus of FIG. 1, wherein the mold arrangement is arranged in an open state.

FIG. 12 illustrates, schematically, in a perspective view, the upper portions of the apparatus of FIG. 1, wherein the movement of a clamping unit comprised in the apparatus is indicated.

FIG. 13 illustrates, schematically, in an enlarged perspective view, the clamping unit shown in FIG. 12, wherein the tilting of the top mold block is indicated.

FIG. 14 illustrates, schematically, in a perspective view, the apparatus of FIG. 1, wherein a pump and injection system as being comprised in the apparatus of FIG. 1 is observable.

FIG. 15 illustrates, schematically, in cross section of the recoated fiber end portions, wherein various dimensions of the bare fiber, of the original coating, and of the recoating, respectively, are indicated.

### DETAILED DESCRIPTION OF EMBODIMENTS

In the following description, for purposes of explanation and not limitation, specific details are set forth, such as particular techniques and applications in order to provide a thorough understanding of the present invention. However, it will be apparent to one skilled in the art that the present invention may be practiced in other embodiments that depart from these specific details. In other instances, detailed descriptions of well-known methods and apparatuses are omitted so as not to obscure the description of the present invention with unnecessary details.

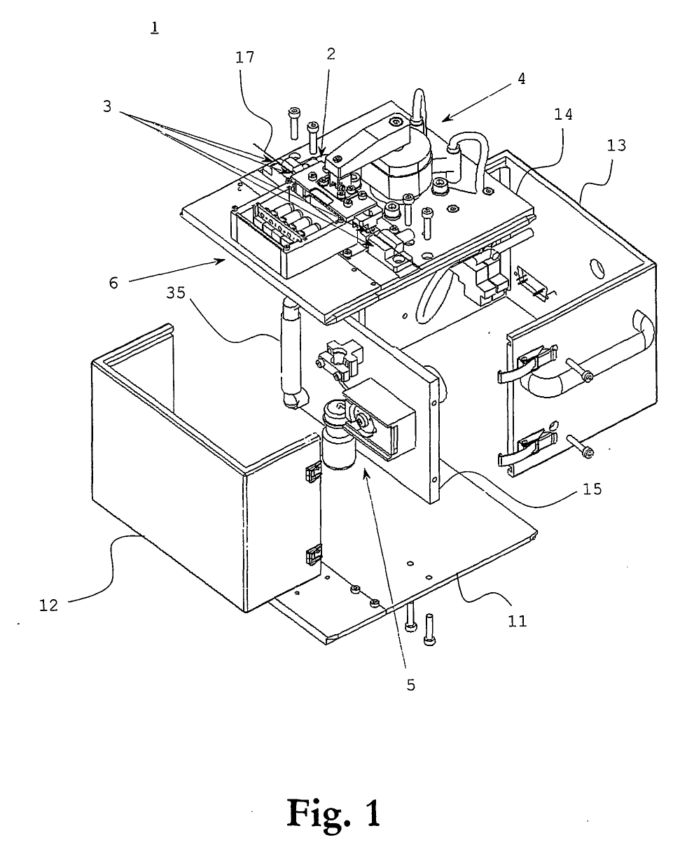

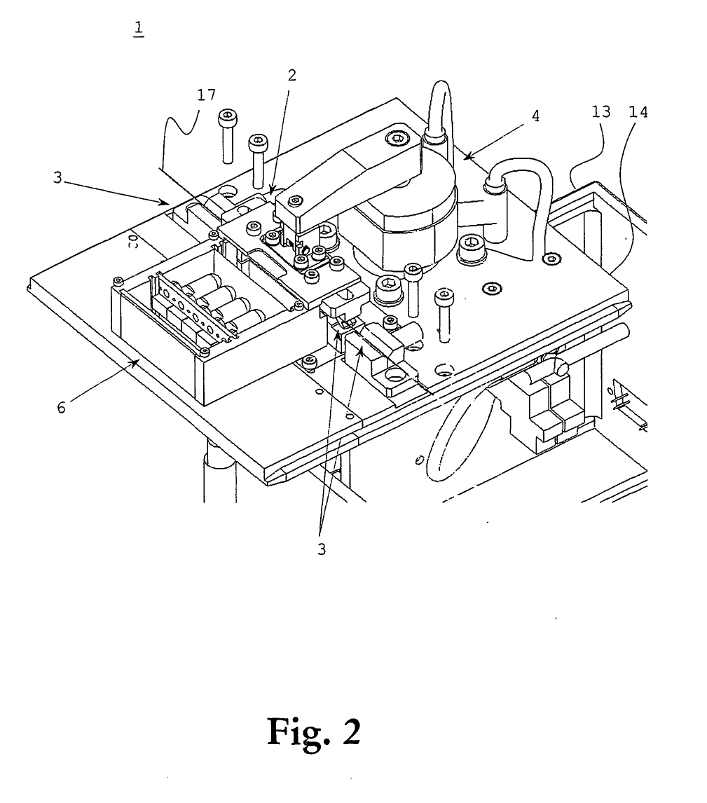

With reference to FIGS. 1 and 2, which schematically, in exploded perspective views, illustrate a recoating apparatus 1 for recoating spliced end portions of two lengths of optical fibers 17, an embodiment of the present invention will be overviewed. The apparatus comprises five main parts or components: a mold arrangement 2 including a mold cavity, a holding and stretching arrangement 3, a movement and clamping unit 4, a pump and injection system 5, and a UV curing system 6 to be thoroughly described below.

Further, apparatus 1 comprises a bottom base mounting plate 11, two side walls 12, 13, and a top base mounting plate 14, together defining a casing, which houses some of components 2-6 or parts thereof. Further, within the casing is a supporting plate 15 arranged between bottom and top base plates and perpendicular thereto for supporting further parts of components 2-6. Apparatus 1 may further be provided with a central control unit, e.g. a microcomputer (not illustrated) for controlling the operation of apparatus 1, and a power supply unit for supplying apparatus 1 with electrical power (not illustrated in FIG. 1).

Recoating apparatus 1 is particularly suited to be used for molding a recoating of acrylate. Acrylate has good adhesion to the uncoated glass fiber, and has good optical properties; i.a. it couples out higher undesired optical modes. Further, it is UV curable, which provides for fast curing, it is dense and does thus not absorb moisture.

However, any other suitable UV curable molding material, such as e.g. various epoxies, may be used in the present invention.

Further, recoating apparatus 1 may be used i.a. for fabrication of long-haul transmission fiber, for repairs of optical fiber, as well as in the fabrication of optical modules.

Yet further, recoating apparatus 1 may be used i.a. as an industrial stand-alone recoater, as a field recoater, or as an integrated part of a complete fiber-splicing machine. Recoating apparatus 1 may be provided with a robot arm (not illustrated) for automated insertion and removal of the optical fiber.

Mold Arrangement

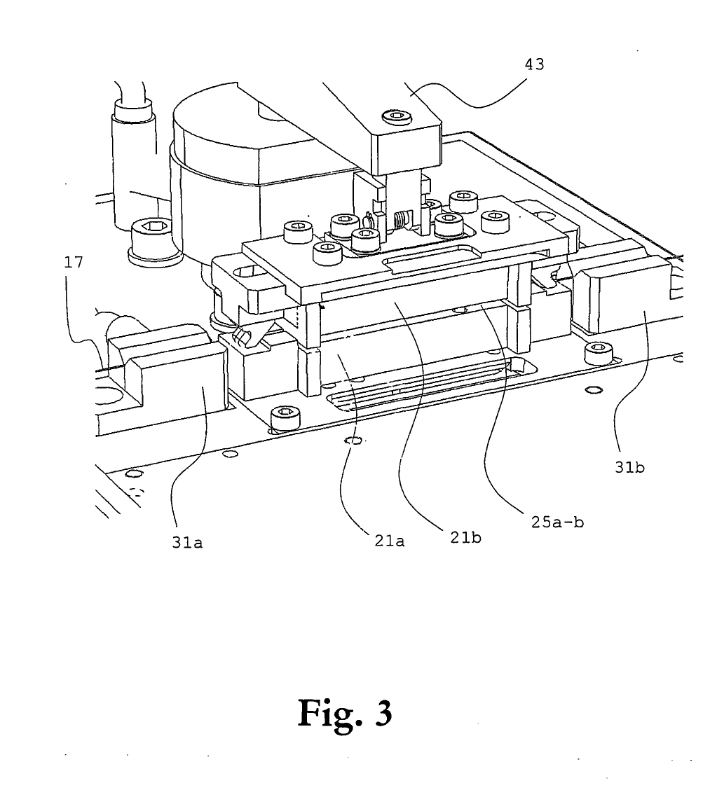

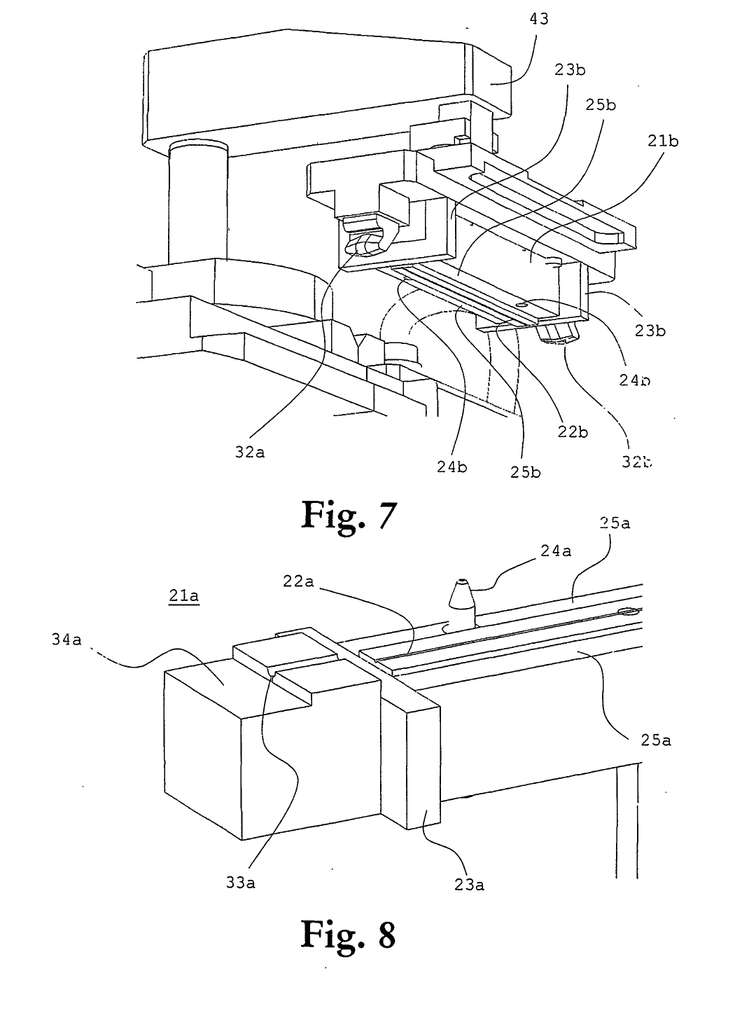

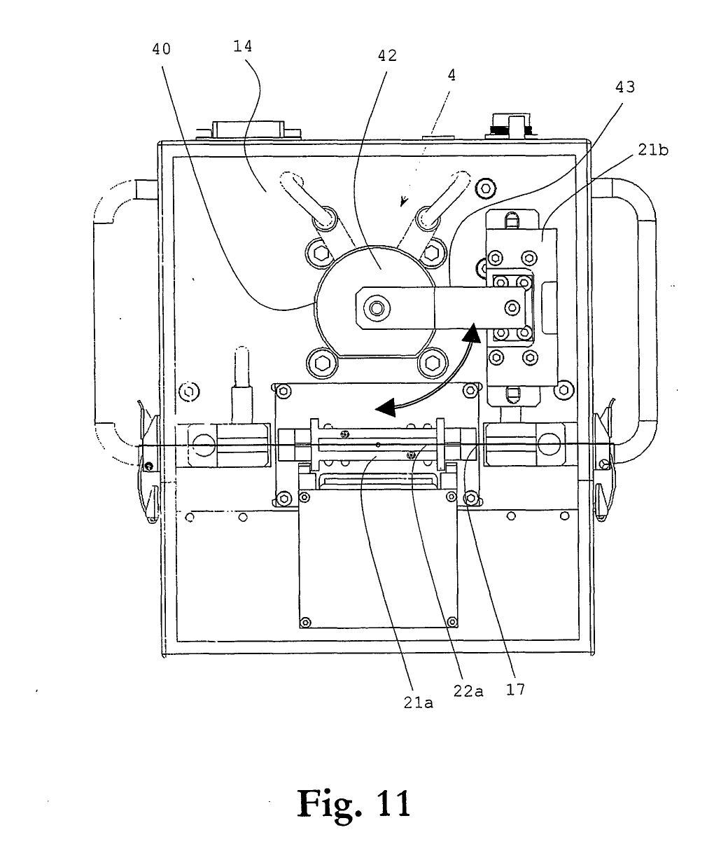

With reference to FIGS. 3-7 and 11 mold arrangement 2 will be described in more detail. Mold arrangement 2 comprises a bottom 21a and a top 21b mold block, each of which includes a longitudinally extending groove 22a, 22b in a surface thereof. Bottom mold block is firmly mounted on upper base plate 14 by means of two U-bolts or cramps 23a. Top mold block 21b is mounted at a lever 43 of movement and clamping unit 4 by means of two U-bolts or cramps 23b and is movable by means of this unit so as to reach either a closed state (FIG. 3), in which the longitudinally extending grooves 22a, 22b cooperate to form a mold cavity for the optical fiber end portions 17, or an open state (FIG. 11), in which the optical fiber end portions 17 are insertable into and removable from longitudinally extending groove 22a of bottom mold block 21a.

Alternatively, in order to reduce any stress or strain in the mold blocks 21a-b these may be secured to the upper base plate 14 and to the lever 43, respectively, or in the latter case to a substrate plate, which in turn is secured to the lever 43, by means of gluing or by means of directly mold the blocks on respective plates.

The grooves 22a, 22b are preferably semi-circular such that longitudinally extending grooves have each a semi-circular cross section, such that the grooves, in the closed mold block state, cooperate to form a mold cavity having a circular cross section.

The grooves may be fabricated by milling with a round-end mill of e.g. 300 Mm. The quality of the mold cavity shape is in such case directly proportional to the tolerances of the mill and the precision achieved when machining the mold. Other fabrication methods may be used such as e.g. extrusion, different moldings, melting or even cutting the mold with a proper tool.

The diameter of the mold cavity 22a, 22b is preferably at the smallest, slightly larger than the original fiber coating diameter in order to let out the air that is trapped inside the mold cavity when the acrylate is injected. In a typical case, the bare glass fiber (core and cladding) has a diameter of 125 μm, the original coating has a diameter of 250 μm, and the mold cavity has a diameter of 300 μm. The mold cavity diameter can be minimized to around 260 μm if desirable. However, a smaller recoating diameter implies a thinner overlapping between recoating and coating, which may be less dense and thus sensitive to moisture. Further, it may be fragile and thus easily damaged or broken.

Further, bottom mold block 21a is provided with two alignment pins 24a and top mold block 21b is provided with two openings 24b, such that openings 24b can receive alignment pins 24a when said mold blocks are moved to said closed state so as to align said mold blocks with respect to each other. Alternatively, other alignment means known in the art is provided.

According to the present invention at least one of the mold blocks, preferably the top mold block 21b, is made of a plastic material comprising a fluoroplastic, wherein said plastic material is at least partly transparent to UV light to enable UV curing system 6 to irradiate UV curable recoating material injected into mold cavity 22a, 22b with UV light through this mold block.

Also the other of the mold blocks, i.e. bottom mold block 21a, may be made of such plastic material comprising a fluoroplastic. Alternatively, mold block 21a comprises a reflector (not. illustrated) for reflecting UV light, which is passed mold cavity 22a, 22b back towards mold cavity 22a, 22b, or it may be made of a UV reflective or opaque material.

The fluoroplastic-containing plastic material has advantageously a surface tension of less than 50 N/m, more preferably less than 40 N/m, and most preferably less than 30 N/m.

The fluoroplastic is chosen from the group of PCTFE, FEP, PFA, PTFE, ETFE and ECTFE, and the plastic material may be a mixture of a fluoroplastic and any other suitable plastic material. Preferably, however, the plastic material is constituted by the fluoroplastic only.

The fluoroplastics have the lowest surface-tension of the plastic materials. A low mold surface-tension implies that the acrylate will not stick to the mold. Such low adhesion to the recoated acrylate is favorable when the recoated fiber is to be released from the recoating molds in a smooth way, not causing any stress or damages to the recoated fiber.

Some of the fluoroplastics are transparent to UV light. A material that is transparent to UV light is desirable for at least one of the two molds in order to be able to cure the injected acrylate. The recoating material must additionally be unaffected by the UV radiation in terms of mechanical and chemical stability.

Further, fluoroplastics are chemically non-reactive with the injected acrylate and they have a fairly good machineability.

The molds have to be mechanically stable even after being used hundreds of times and they should have high temperature stability. Further, if the bare fiber would come into contact with mold, the mold should not cause damage (micro-cracks) to the splice area reducing the splice-points strength. Molds of a fluoroplastic material may exhibit such properties.

Fluoroplastics are also repellent to chemicals and dirt that might be exposed to the recoating molds. Further, a fluoroplastic mold can be cleaned with alcohol or acetone if needed; thus the mold has to be unaffected to alcohol or acetone.

PCTFE or polychlorotrifluoroethylene has a very good mechanical strength and has the best machineability among these three fluoroplastics. It has also a good UV transparency and good anti-sticking properties. FEP is softer than PCTFE which makes it more difficult to machine, but this implies probably less need for applying a high contact pressure to the recoating mold blocks. The optical clearness is not as good as that of PCTFE but satisfactory. The anti-stick properties to acrylate are better than those of PCTFE. PFA has properties that are very similar to those of FEP.

A particular feature of the present embodiment is that the top mold block 21b includes a cut away portion 25b from the surface wherein groove 22b is defined. Such cut away portion or recess 25b are preferably arranged so as to reduce the distance UV light from UV curing system 6 has to propagate through the fluoroplastic-containing plastic mold block before reaching mold cavity 22a, 22b, i.e. one of recesses 25 shall be arranged along a straight line between mold cavity 22a, 22b and the UV light source of UV curing system 6. In such manner any absorption by the mold block 21b is reduced and this implies that the curing time is reduced or that light sources of lower power may be employed.

A second benefit of the recess 25b is that it reduces the contact area between the mold blocks 21a, 21b, which in turn increases the clamping pressure given a constant clamping force. In such manner the risk of achieving burrs or wings at the recoating, due to low contact pressure, maybe eliminated, or at least reduced. This is necessary as the occurrence of wings inevitably leads to the contamination of the contacting surfaces of the mold blocks, and thus the mold blocks have to be cleaned subsequent to each recoating. This is hardly done in a completely automatic recoating process.

The benefit of providing a mold block having a cut away portion in its mold block receiving surface compared with just providing smaller mold blocks is that the mechanical stability and other mechanical properties are better for a larger mold block. Further, a certain size of the mold block is favorable in respect of manageability and easiness of handling.

Further, the fluoroplastic-containing mold block may include a second cut away portion or recess 25b tangentially spaced from the previous mentioned recess. This may be particularly advantageous if curing system 6 comprises two tangentially spaced UV radiation sources, wherein each is adapted for irradiating said mold cavity through a respective one of recesses 25b.

Additionally, the top mold block 21a may be provided with such cut away portions or recesses 25a, and if this mold block 21a also is of a UV transparent material the complete mold cavity 22a, 22b will be reached by UV radiation from UV curing system through the notch formed by recesses 25a, 25b (see FIG. 3).

Recesses 25a, 25b may also affect the impact of cramps 23a, 23b on the flatness of the contacting mold surfaces in a favorable way.

The design of the molds is of greatest importance for the recoating result. The demand on recoating concentricity and roundness varies, but for some customers, particularly some component manufacturers, it is very important. The aim when designing the recoating apparatus mold is to achieve a mold that fulfils those criteria and withholds the given tolerances even after being used several times.

Holding and Stretching Arrangement

A holding arrangement, which can be seen in e.g. FIG. 3, comprises a pair of fiber holders 31a, 31b arranged for holding lengths of the optical fibers 17 in alignment with the longitudinal central axis of mold cavity 22a, 22b. The fiber holders comprise each a vacuum chuck arranged on either side of the mold blocks. Each of the vacuum chucks includes a groove extending parallel with the longitudinal axis of the mold cavity. The grooves are connectable to a vacuum ejector 35 (FIG. 1) for supplying vacuum to the vacuum chuck grooves in order to gently hold the fibers in place.

Excess air from the vacuum ejector may be led to the UV curing system for air cooling of the UV light source(s) thereof.

Alternatively, other kind of fiber holders may be used such as e.g. mechanical fiber holders.

With reference now to FIGS. 8-10, the stretching arrangement of apparatus 1, which is adapted to stretch and align the optical fiber end portions 17 when mold blocks 21a, 21b are moved into the closed state.

The stretching arrangement comprises a pair of elastic stretchers 32a, 32b mounted on top mold block 21b, the stretchers 32a, 32b being inclined with respect to a plane perpendicular to the longitudinal axis of the mold cavity 22a, 22b, a pair of alignment grooves 33a, 33b arranged in bottom mold block 21a on each side of groove 22b and extending parallel with this groove and a pair of slide surfaces 34a, 34b, each being arranged adjacent a respective of the alignment grooves 33a, 33b.

Grooves 33a, 33b include a bottom portion having a square cross section with a dimension slightly larger than the diameter of the coated fiber, and a top portion having a semicircular cross section of a larger dimension for easy reception of the fiber end portions 17. The slide surfaces 34a, 34b are arranged at a level coinciding with the bottom of grooves 33a, 33b.

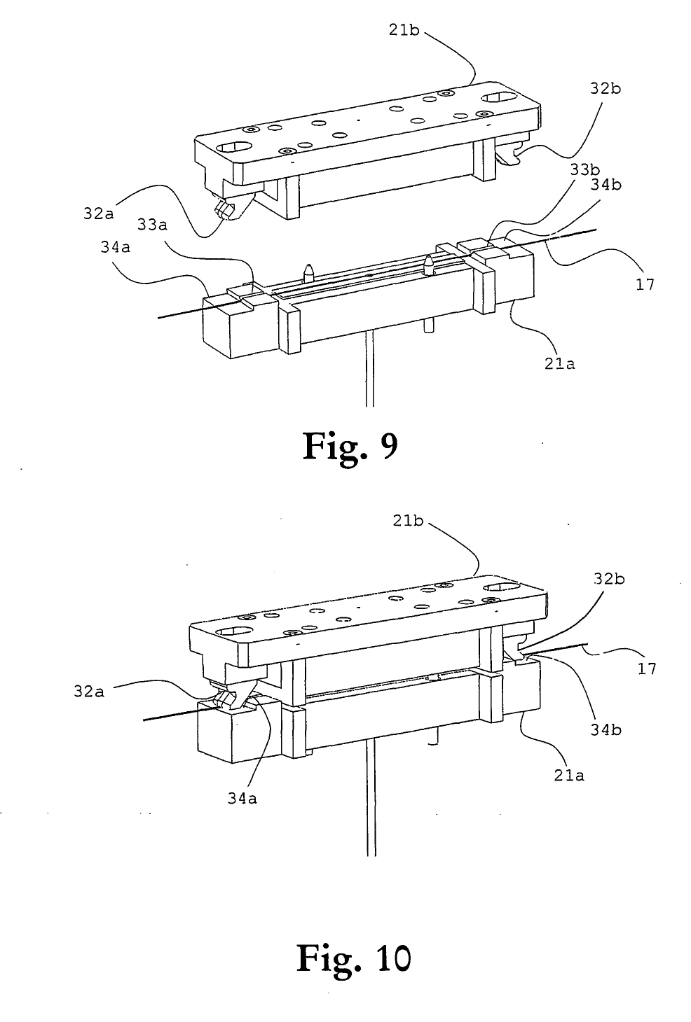

The size and orientation of the stretchers 32a, 32b, grooves 33a, 33b and slide surfaces 34a, 34b are such that the stretchers 32a, 32b and slide surfaces 34a, 34b can cooperate to stretch and align the optical fiber end portions with the central longitudinal axis of cavity 22a, 22b when mold blocks 21a, 21b are moved into the closed state (see particularly FIGS. 9-10).

By such provision it is safeguarded that the optical fiber end portions are held aligned within mold cavity such that a recoating can be molded with a uniform thickness longitudinally as well as circumferentially. If the described stretching mechanism is not used the fiber portions 17 may be misaligned due to the fiber portions own gravity or curl, or due to surface tension or electrostatic forces.

In the present embodiment the alignment grooves 33a, 33b and the slide surfaces 34a, 34b are integrated parts of the bottom mold block 21a. While such a solution provides for exact alignment of the alignment grooves 33a, 33b and the slide surfaces 34a, 34b with respect to the mold cavity-forming grooves 22a, 22b it may result in high manufacturing costs of rather complex mold blocks.

In alternative versions of the invention the alignment grooves 33a, 33b and/or the slide surfaces 34a, 34b may be provided as separate units mounted on base plate 14 or these components are together provided as a single unit. The mounting involves in such instance the alignment of such component(s) with respect to the bottom mold block 21a. Further, other slide surfaces 34a, 34b than plastic ones may be provided as long as the coated fiber end portions 17 and the stretchers 32a, 32b have the capability of sliding on the surfaces.

In yet an alternative version of the invention the alignment grooves 33a, 33b may be provided with apertures or similar at the bottoms thereof, wherein said apertures may be connected to a source of vacuum in order to gently hold the fibers 17 in place. In such instance the fiber holders 31a, 31b may be dispensed with.

Another aspect that is worth considering is the impact an eventual bare fiber contact with the recoat mold could have on the final strength of the spliced and recoated fiber. Studies show that contact with bare fiber before and after splicing decreases the strength of the fiber-joint. The reason might be the extension of micro-cracks around the contact area. In such case the hardness of the cured recoating material and the diameter of the recoat cavity can be parameters that have to be considered and optimized. This bare fiber contact problem is, however, easily avoided by the provision of the above described fiber stretching and aligning arrangement, and careful insertion of the fiber end portions in the recoating apparatus 1.

In the closed mold state the vacuum can be turned off since the fiber is held by the rubber fiber stretchers. Closing the vacuum might help to build up more cylinder pressure for the clamping unit 6. On the other hand, the cooling effect produced by the waste air from the ejector does not work when the vacuum is turned off.

Movement and Clamping Unit

With reference principally to FIGS. 11-13, the movement unit 4 of recoating apparatus 1 for moving top mold block 21b between said open and said closed and clamped mold block states, will be depicted.

Movement and clamping unit 4 is preferably a double acting pivotable clamping unit having a pneumatically driven and vertically arranged piston 41 within a cylinder 42, which is firmly mounted on the upper base mounting plate. A horizontal lever 43 is firmly mounted at the upper end of piston 41 and the top mold block 21b is in turn mounted at an outer end of lever 43. Further, piston 41 and cylinder 42 are provided with engagable grooves or similar (not illustrated) such that piston is forced to rotate during portions of the stroke.

The opened mold block state is shown in FIG. 11, wherein the pivotal movement is indicated by the curved arrow, whereas the closed mold block state is shown i.a. in FIG. 2.

A preferred clamping unit is marketed by DE-STA-CO as model No. 89401-4. Such clamping unit 4 has a pivoting stroke, in which the top mold block is pivoted relative the bottom mold block, and a linear clamping stroke, in which the first and second mold blocks are clamped together to reach the closed state. During the pivotal stroke a 90° turn is made simultaneously with a 10 mm stroke. During the clamping stroke an additional 10 mm movement is achieved, guided by mold alignment pins 24a.

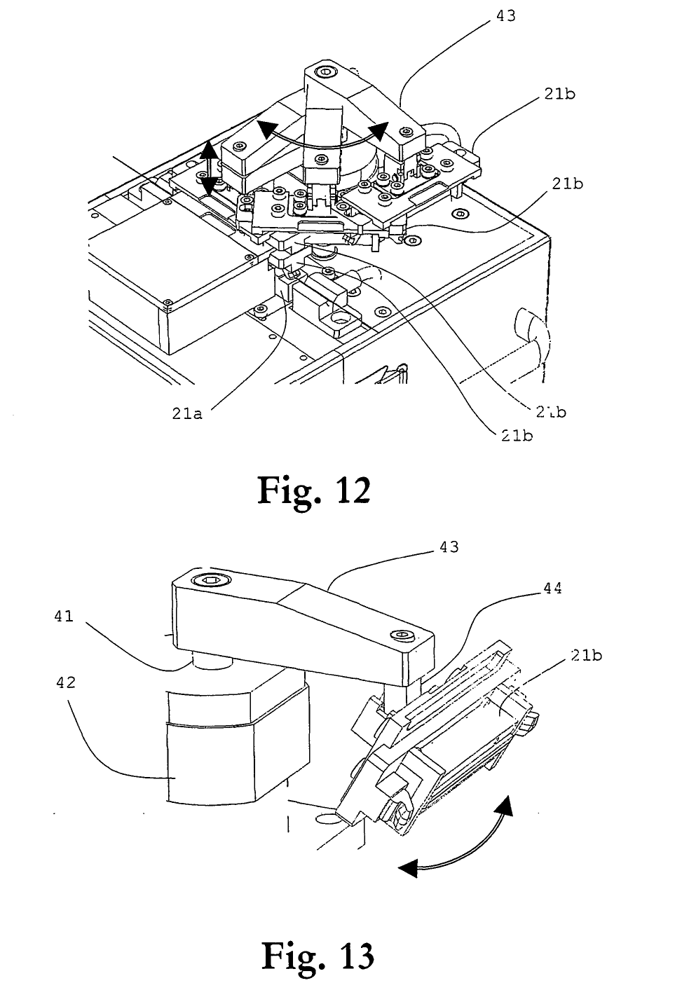

FIG. 12 shows the clamping unit 4 and the top mold 21b in four different positions; in the fully opened mold block state, in an intermediate part of the pivotal stroke (the pivotal movement is indicated by the curved arrow), at the end of the pivotal stroke (being the start position of the linear clamping stroke), and in the fully closed and clamped mold block state (the linear movement during the clamping stroke is indicated by the vertical arrow).

When pressing the recoating mold blocks together with the pneumatic cylinder using compressed air of 6 bar, the cylinder delivers a force of about 100 N (10 kp). With a mold contact area of 225 mm² this equals a contact pressure of 0.44 MPa. Such pressure may be necessary in order to avoid the creation of wings at the recoating. The contact pressure of the recoating molds can be regulated with a pressure regulator. Further, the movement speed can also be regulated with a flow valve.

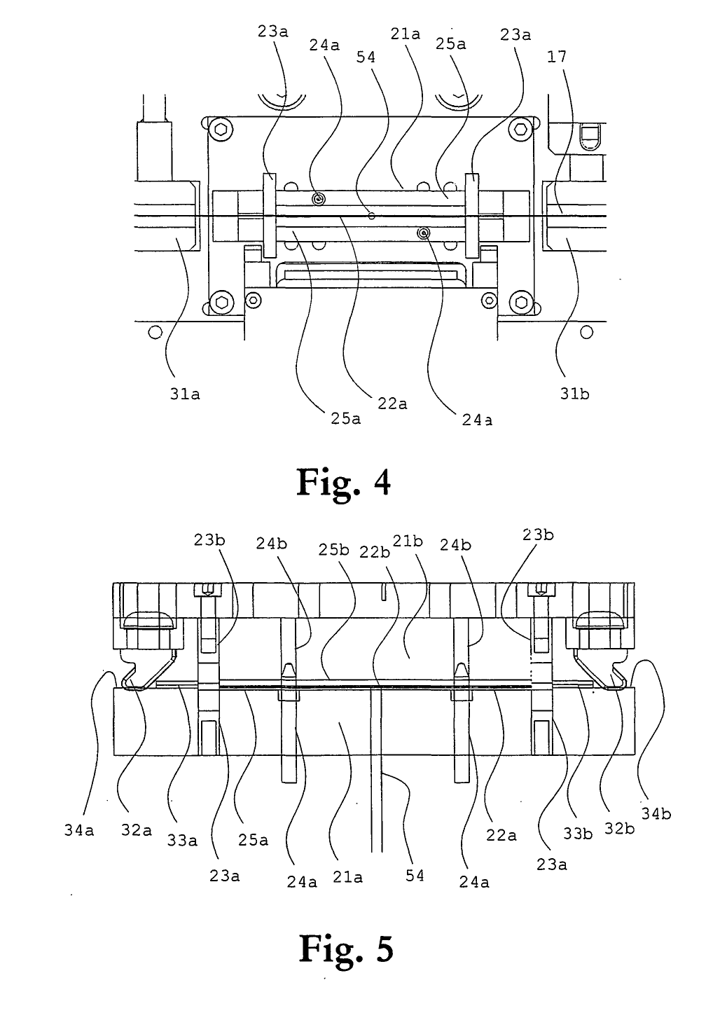

FIG. 13 illustrates, schematically, a mechanism for tilting the top mold as being comprised in the movement mechanism of FIG. 4a. The tilting mechanism is achieved by means of attachment 44 to the clamping unit lever 43 such that top mold 21b is pivotably movable around a pivot axis being parallel with its longitudinally extending groove (i.e. movable as indicated by the FIG. 13 curved arrow). The pivotably movable attachment 44 is preferably spring biased into its non-tilted position. Top mold is preferably tiltable up to 90° to expose its contact surface. The top mold block can be locked in this tilted position by means of a locking mechanism (not illustrated). This tilt mechanism facilitates inspection and cleaning of the top mold block if necessary.

Pump and Injection System

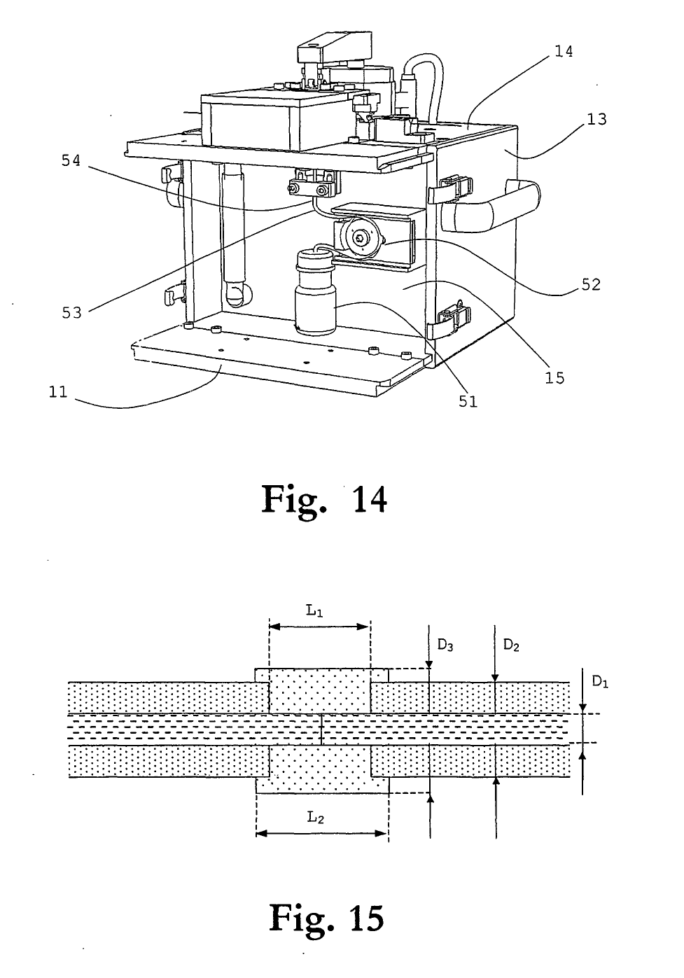

With reference now to FIG. 14 pump and injection system 5 of recoating apparatus 1 will be described.

Pump and injection system 5 comprises a container 51 for the UV curable recoating material, a peristaltic pump 52 and a tubing system 53, possibly including pipe couplings, fittings, and/or hose clamps, for transporting the UV curable recoating material from the container to the mold blocks, and an injection needle 54 mounted within one of the mold blocks and through which the UV curable recoating material can be brought.

Injection needle 54 is also indicated in FIGS. 4-6. Injection needle 54 is, at least adjacent to mold cavity 22a, 22b, opaque to UV light to secure that no injection plug is obtained at the recoating. A preferred manner of fabricating the bottom mold block/injection needle combination is to make a through hole, in which the injection needle is mounted. Subsequently thereto, the longitudinally mold cavity-forming groove 22a is formed such that groove 22a is in open communication with the injection needle. In such manner the tip of the injection needle will follow the semi-circular inner surface of groove 22a and any occurrence of injection plugs at the recoating is avoided.

If a UV opaque bottom mold is employed the needle does not have to be made of a UV opaque material. In the latter case the needle can be an integrated part of the bottom mold block and thus only a through hole have to be provided in the bottom mold block.

A peristaltic pump commercially available from Alitea Watson Marlow may be used. This pump is primarily intended for dosage of medication, but is suitable also for the present purpose. The characteristics of this peristaltic pump are highly dependent on the pump tubing applied in the pump.

Alternatively, a piston pump, basically a linear stepping motor pushing a syringe piston, or an air dispenser could possibly be used instead of the peristaltic pump. Using a positive dispenser, or a positive displacement rod valve as known within the displace valve technology field would also be a possible alternative to the peristaltic pump. Such displacement pumps would be more accurate and precise compared to the peristaltic pumps, but would need regular cleaning with alcohol since they would otherwise be clogged with cured or partly cured recoating material.

Typically, a peristaltic pump is preferred in an industrial stand-alone recoater, as a field recoater, which is typically used in a discontinuous manner, and a displacement pump is preferred in a recoater used as an integrated device in an automatic fiber splicing machine, is typically used in more or less continuously.

Pump 52 may be driven by any of a DC motor, a servo motor, and a stepping motor (not illustrated), whereby the motor is preferably geared.

The volume to be injected for recoating varies depending e.g. on the stripped length of the fiber. The volume may be estimated from the dimensions specified in FIG. 15, which is a cross section of the recoated optical fiber end portions. The determining dimensions are length L₁ of uncoated fiber, the desired length L₂ of the recoating, and the diameters of the uncoated fiber D₁, of the coated fiber D₂, and of the mold cavity (i.e. of the recoating) D₃. Note that the Figure is not to scale, and that the invention may provide for smoother recoating ends than those schematically illustrated.

Pump 52 may be adapted to pump the UV curable recoating material at a first velocity during a first part of the mold injection, and at a second velocity during a latter part of the mold injection, the second velocity being substantially lower than said first velocity. By such approach it is ensured that the pressure within the cavity is not raised so as to cause burrs or wings at the recoating, which in turn may contaminate the contacting surfaces of the mold blocks. Additionally, this may give a fast injection combined with an exact dosage.

Optionally, the pump 52 may be adapted to pump the UV curable recoating material in a three-stage operation: at a first velocity during an initial part of the mold injection, at a second velocity during an intermediate part of the mold injection, where the first velocity is higher than the second velocity, and at in a reversed direction, i.e. backwards towards the container 51, at a final part of the mold injection. The precision of the mold injection will in this instance be yet improved.

Alternatively, or optionally, a valve may be arranged in the tubing system 53 between the pump 52 and the injection needle 54 to control the amount of recoating material pumped into the injection needle 54.

UV Curing System

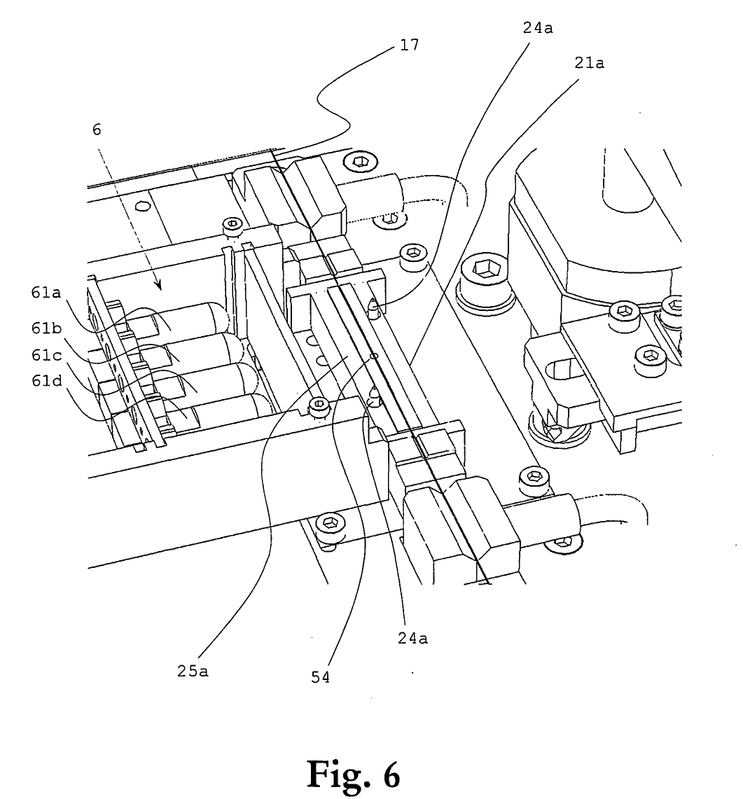

Returning now to FIG. 6 the UV curing system 6 of recoating apparatus 1 will briefly be described. UV curing system 6 comprises an array of five halogen lamps, of which four 61a-d are observable in FIG. 6, arranged so as to illuminate the complete longitudinal extension of mold cavity 22a, 22b. Since it is desired to reduce the curing time the emitted light can be properly focused to concentrate the light intensity where needed.

A further possibility is to use two or more separate arrays of UV sources and to irradiate the mold cavity from two directions. Advantageously, the two arrays are arranged so as direct UV light through a respective one of the recesses 25a of mold block 21b to reduce UV absorption by the mold block as mentioned above in connection with the description of the mold arrangement. Such UV arrays may be oriented to irradiate the mold cavity 22a, 22b directly, or via some kind of mirror arrangement. In the latter case the arrays may be arranged at the upper base plate 14 at each side of the bottom mold block 21a to irradiate substantially vertically upwards, and two mirrors may be arranged to direct the light towards the mold cavity 22a, 22b.

Alternatively, other kind of UV emitting sources such as e.g. mercury xenon lamps may be employed.

Operation of the Inventive Recoating Apparatus

The operation of the inventive recoating apparatus will in the following be briefly overviewed.

The mold blocks are opened, if they are not already open (opened state illustrated in FIG. 11). Then, the spliced optical fiber end portions 17 are inserted into longitudinally extending groove 22a of bottom mold block 21a, and positioned within the grooves of fiber holders 31a, 31b. Vacuum is supplied to fiber holders 31a, 31b if not already present. Compressed air is supplied to clamping unit 4 such that upper mold block 21b is moved (illustrated in FIG. 12) to reach the closed clamped state, in which longitudinally extending grooves 22a, 22b cooperate to form the mold cavity for the spliced optical fiber (illustrated in FIGS. 1-3, 5 and 10).

While closing the mold, the stretchers 32a, 32b and the grooves 33a, 33b cooperate to stretch and align the spliced optical fiber along the central longitudinal axis of cavity 22a, 22b (FIG. 10). In such manner it is secured that a uniform recoating is obtained.

The UV curable recoating material, i.e. the acrylate, is then injected into the mold cavity 22a, 22b by means of pump and injection system 5 (FIG. 14). Subsequently thereto, the UV curable recoating material injected into the mold cavity is irradiated with UV light by means of the UV curing system (FIG. 6). In such manner the recoating material is polymerized and solidified. Finally, the mold blocks 21a, 21b are opened, and the spliced recoated optical fiber is removed from the apparatus.

The fact that at least the top mold block 21b is made of a plastic material comprising a fluoroplastic, which is UV transparent and has low adhesion to the molding acrylate material, makes both UV curing (by irradiating light through mold block 21b) and removal of the recoated fiber easy and unproblematic.

If the apparatus is provided with a robot arm or similar, the spliced optical fiber may be inserted into grooves 22a, 33a, 33b and into fiber holders 31a, 31b, and may be removed from recoating apparatus in an automated fashion. In such manner the inventive recoating apparatus may be completely automatic.

In such instance the fiber may be arranged in two mechanical fiber holders and the robot arm may handle and move the fiber by means of gripping the fiber holders, move the fiber/fiber holder combination, and release the fiber holders. Conveniently, fiber holders 31a, 31b are then dispensed with, and the fiber/fiber holder combination is arranged in the recoater by means of releasably mounting the mechanical fiber holders at the illustrated position of the fiber holders 31a, 31b.

Further, the recoater may be provided with a vacuum sensor and alarming and/or locking means (not illustrated) arranged to alarm the user and/or lock the recoating material injection depending on the vacuum sensor detecting that no fiber is present in the vacuum chucks 31a, 31b, or in the case of a movable fiber/fiber holder combination that no fiber holders are mounted at the illustrated position of the fiber holders 31a, 31b. By such provisions it is safeguarded that no recoating material will be injected into an empty mold cavity and contaminate the same.

It will be obvious that the invention may be varied in a plurality of ways. Such variations are not to be regarded as a departure from the scope of the invention. All such modifications as would be obvious to one skilled in the art are intended to be included within the scope of the appended claims.

1. An apparatus (1) for recoating uncoated and spliced end portions of optical fibers (17), said apparatus comprising:
a first (21a) and a second (21b) mold block, respectively, each of which includes a longitudinally extending groove (22a, 22b) in a surface thereof, said first and second mold blocks being mutually arrangable in a closed state, in which said longitudinally extending grooves cooperate to form a mold cavity for said optical fiber end portions, and in an open state, in which said optical fiber end portions are insertable into and removable from one of said longitudinally extending grooves;
an injection system (5) for injecting a UV curable recoating-material into said mold cavity; and
a UV curing system (6) for irradiating said UV curable recoating material injected into said mold cavity with UV light, thus curing said recoating material,
characterized in
that at least one of said mold blocks is made of a plastic material comprising a fluoroplastic, said plastic material being at least partly transparent to UV light to enable said UV curing system to irradiate said UV curable recoating material injected into said mold cavity with UV light through said at least one of said mold blocks.

2. The apparatus as claimed in claim 1, wherein said plastic material has a surface tension of less than 50 N/m, preferably less than 40 N/m, and more preferably less than 30 N/m.

3. The apparatus as claimed in claim 1 or 2, wherein the fluoroplastic is chosen from the group of PCTFE, FEP, and PFA, PTFE, ETFE and ECTFE.

4. The apparatus as claimed in any of claims 1-3, wherein said at least one of said mold blocks made of a plastic material comprising a fluoroplastic, includes a recess (25b) arranged so as to reduce the distance said UV light from said UV curing system has to propagate through said at least one of said mold blocks made of a plastic material comprising a fluoroplastic, before reaching said mold cavity.

5. The apparatus as claimed in claim 4, wherein said at least one of said mold blocks made of a plastic material comprising a fluoroplastic, includes a second recess (25b) tangentially spaced from said first recess, and said curing system comprises a first and a second UV radiation source, each being adapted for irradiating said mold cavity through a respective one of said first and second recesses.

6. The apparatus as claimed in any of claims 1-5, wherein said at least one of said mold blocks made of a plastic material comprising a fluoroplastic, is a top mold block.

7. The apparatus as claimed in claim 6, wherein also said second mold block, being a bottom mold block, is made of a plastic material comprising a fluoroplastic.

8. The apparatus as claimed in claim 7, wherein said second mold block, being a bottom mold block, comprises a reflective means for reflecting UV light, which is passed said mold cavity, towards said mold cavity.

9. The apparatus as claimed in claim 8, wherein said second mold block, being a bottom mold block, is made of a UV reflective or opaque material.

10. The apparatus as claimed in any of claims 1-9, wherein the longitudinally extending grooves have each a semi-circular cross section, such that the grooves, in the closed mold block state, cooperate to form a mold cavity having a circular cross section.

11. The apparatus as claimed in any of claims 1-10, wherein one of said mold blocks is provided with alignment pins (24a) and the other one of said mold blocks is provided with openings (24b), such that said openings receive said alignment pins when said mold blocks are arranged in said closed state so as to align said mold blocks with respect to each other.

12. The apparatus as claimed in any of claims 1-11, wherein said apparatus comprises a fiber holder (31a, 31b) for holding coated lengths of said optical fibers in alignment with the longitudinal axis of said mold cavity.

13. The apparatus as claimed in claim 12, wherein said fiber holder comprises a pair of vacuum chucks (31a, 31b) arranged on either side of the mold blocks, each of which vacuum chucks includes a groove extending parallel with the longitudinal axis of the mold cavity and being connectable to a vacuum ejector (35) for supplying vacuum to the vacuum chuck grooves.

14. The apparatus as claimed in claim 13, wherein said apparatus comprises means for guiding excess air from the vacuum ejector to the UV curing system for cooling.

15. The apparatus as claimed in any of claims 1-14, wherein said apparatus comprises stretching means (32a, 32b), preferably of an elastic material, for stretching and aligning said optical fiber end portions when said first and second mold blocks are arranged in said closed state.

16. The apparatus as claimed in claim 15, wherein said stretching means comprises a pair of elastic stretchers (32a, 32b) mounted on the first mold block and being inclined with respect to a plane perpendicular to the longitudinal axis of the mold cavity, and a pair of slide surfaces arranged at the second mold block and extending parallel with the longitudinal axis of the mold cavity, said stretchers and surfaces cooperating to stretch and align said optical fiber end portions when said first and second mold blocks are arranged in said closed state.

17. The apparatus as claimed in any of claims 1-16, wherein said apparatus comprises a pivotable clamping unit (40) for moving the first and second mold blocks relative each other between said open and said closed states.

18. The apparatus as claimed in claim 17, wherein said pivotable clamping unit is a double acting pivotable clamping unit, preferably pneumatically driven, and having a pivoting stroke, in which the first and second mold blocks are pivoted relative each other, and a clamping stroke, in which the first and second mold blocks are clamped together to reach the closed state.

19. The apparatus as claimed in claim 17 or 18, wherein one of the first and second mold blocks is attached to the clamping unit such that it is pivotably movable around a pivot axis being parallel with its longitudinally extending groove, said pivotably movable attachment being preferably spring biased.

20. The apparatus as claimed in any of claims 1-19, wherein said injection system comprises a container (51) for the UV curable recoating material, a peristaltic pump (52) and a tubing system (53) for transporting the UV curable recoating material from the container to the mold blocks, and an injection needle (54) mounted within one of the mold blocks and through which the UV curable recoating material is brought.

21. The apparatus as claimed in claims 20, wherein said injection needle, at least adjacent to said mold cavity, is opaque to said UV light.

22. The apparatus as claimed in claim 20 or 21, wherein the pump is driven by any of a DC motor, a servo motor, and a stepping motor, said motor being preferably geared.

23. The apparatus as claimed in any of claims 20-22, wherein the pump is adapted to pump the UV curable recoating material at a first velocity during a first part of said injection, and at a second velocity during a latter part of said injection, said second velocity being substantially lower than said first velocity.

24. An apparatus for splicing optical fibers, said apparatus comprising the apparatus for recoating uncoated and spliced end portions of said optical fibers as claimed in any of claims 1-23.

25. The apparatus as claimed in claim 24, comprising a robot arm for inserting said optical fiber end portions into said one of said longitudinally extending grooves and for removing the recoated optical fiber end portions from said longitudinally extending groove.

26. A method for recoating uncoated and spliced end portions of optical fibers (17), said method comprising:
arranging a first (21a) and a second (21b) mold block, respectively, each of which includes a longitudinally extending groove (22a, 22b) in a surface thereof, in an open state, in which said optical fiber end portions are insertable into and removable from one of said longitudinally extending grooves;
inserting said optical fiber end portions into one of said longitudinally extending grooves;
arranging said first and second mold blocks in a closed clamped state, in which said longitudinally extending grooves cooperate to form a mold cavity for said optical fiber end portions;
injecting a UV curable recoating material into said mold cavity;
irradiating said UV curable recoating material injected into said mold cavity with UV light, thus curing said recoating material;
arranging said first and second mold blocks in the open state; and
removing said optical fiber end portions from said one of said longitudinally extending grooves,
characterized in
that the step of irradiating comprises transmitting said UV light through at least one of said mold blocks, wherein said at least one of said mold blocks is made of a plastic material comprising a fluoroplastic, said plastic material being at least partly transparent to UV light.

27. The method as claimed in claim 26, wherein the fluoroplastic is chosen from the group of PCTFE, FEP, PFA, PTFE, ETFE and ECTFE.

28. The method as claimed in claim 26 or 27, wherein the step of irradiating comprises transmitting said UV light through a recess (25b) of said at least one of said mold blocks such that the distance said UV light has to propagate through said at least one of said mold blocks before reaching said mold cavity, is reduced.

29. The method as claimed in any of claims 26-28, wherein the step of arranging said first and second mold blocks in said closed state comprises stretching and aligning said optical fiber end portions by means of a stretching means (32a, 32b), preferably of an elastic material.

30. The method as claimed in claim 29, wherein the step of stretching and aligning said optical fiber end portions by means of said stretching means comprises cooperation between a pair of elastic stretchers (32a, 32b) mounted on the first mold block and being inclined with respect to a plane perpendicular to the longitudinal axis of the mold cavity, and a pair of slide surfaces arranged at the second mold block and extending parallel with the longitudinal axis of the mold cavity.

31. The method as claimed in any of claims 26-30, wherein the steps of arranging said first and second mold blocks in said open and said closed clamped states, respectively, are performed by means of a pivotable clamping unit (40), preferably a pneumatically driven double acting pivotable clamping unit having a pivoting stroke, in which the first and second mold blocks are pivoted relative each other, and a clamping stroke, in which the first and second mold blocks are clamped together to reach said closed clamped state.

32. The method as claimed in any of claims 26-31, wherein the step of injecting a UV curable recoating material into said mold cavity comprises pumping said UV curable recoating material from a container (51) for the UV curable recoating material, through a tubing system (53) and through an injection needle (54) mounted within one of the mold blocks, wherein said injection needle, at least adjacent to said mold cavity, is opaque to said UV light.

33. The method as claimed in claim 32, wherein said UV curable recoating material is pumped through said injection needle at a first velocity during a first part of said injection, and at a second velocity during a latter part of said injection, said second velocity being substantially lower than said first velocity.

34. An apparatus for recoating uncoated and spliced end portions of optical fibers, said apparatus comprising:
a first and a second mold block, respectively, each of which includes a longitudinally extending groove in a surface thereof, said first and second mold blocks being mutually arrangable in a closed state, in which said longitudinally extending grooves cooperate to form a mold cavity for said optical fiber end portions, and in an open state, in which said optical fiber end portions are insertable into and removable from one of said longitudinally extending grooves;
an injection system for injecting a UV curable recoating material into said mold cavity; and
a UV curing system for irradiating said UV curable recoating material injected into said mold cavity with UV light, thus curing said recoating material,
characterized in
that at least one of said mold blocks includes a recess (25b) arranged so as to reduce the distance said UV light from said UV curing system has to propagate through said at least one of said mold blocks made of a plastic material comprising a fluoroplastic, before reaching said mold cavity.

35. The apparatus as claimed in claim 34, wherein said at least one of said mold blocks includes a second recess (25b) tangentially spaced from said first recess, and said curing system comprises a first and a second UV radiation source, each being adapted for irradiating said mold cavity through a respective one of said first and second recesses.

36. An apparatus for recoating uncoated and spliced end portions of optical fibers, said apparatus comprising:
a first and a second mold block, respectively, each of which includes a longitudinally extending groove in a surface thereof, said first and second mold blocks being mutually arrangable in a closed state, in which said longitudinally extending grooves cooperate to form a mold cavity for said optical fiber end portions, and in an open state, in which said optical fiber end portions are insertable into and removable from one of said longitudinally extending grooves;
an injection system for injecting a curable recoating material into said mold cavity; and
a curing system for curing said curable recoating material injected into said mold cavity,
characterized in
stretching means (32a, 32b), preferably of an elastic material, for stretching and aligning said optical fiber end portions when said first and second mold blocks are arranged in said closed state, wherein
said stretching means comprises a pair of elastic stretchers (32a, 32b) mounted on the first mold block and being inclined with respect to a plane perpendicular to the longitudinal axis of the mold cavity, and a pair of slide surfaces (34a, 34b) arranged in or adjacent the second mold block and extending parallel with the longitudinal axis of the mold cavity, said stretchers and surfaces cooperating to stretch and align said optical fiber end portions when said first and second mold blocks are arranged in said closed state.

37. An apparatus for recoating uncoated and spliced end portions of optical fibers, said apparatus comprising:
a first and a second mold block, respectively, each of which includes a longitudinally extending groove in a surface thereof, said first and second mold blocks being mutually arrangable in a closed state, in which said longitudinally extending grooves cooperate to form a mold cavity for said optical fiber end portions, and in an open state, in which said optical fiber end portions are insertable into and removable from one of said longitudinally extending grooves;
an injection system for injecting a curable recoating material into said mold cavity; and
a curing system for curing said curable recoating material injected into said mold cavity,
characterized in
a pivotable clamping unit (40) for moving the first and second mold blocks relative each other between said open and closed states, wherein said movement includes a pivoting movement in a plane coinciding with the surfaces of said first and second mold blocks, in each of which a respective longitudinally extending groove exist, when said first and second mold blocks are arranged in said closed state.

38. The apparatus as claimed in claim 37, wherein said pivotable clamping unit is a double acting pivotable clamping unit, preferably pneumatically driven, and having a pivoting stroke, in which the first and second mold blocks are pivoted relative each other, and a clamping stroke, in which the first and second mold blocks are clamped together to reach the closed state.

39. An apparatus for recoating uncoated and spliced end portions of optical fibers, said apparatus comprising:
a first and a second mold block, respectively, each of which includes a longitudinally extending groove in a surface thereof, said first and second mold blocks being mutually arrangable in a closed state, in which said longitudinally extending grooves cooperate to form a mold cavity for said optical fiber end portions, and in an open state, in which said optical fiber end portions are insertable into and removable from one of said longitudinally extending grooves;
an injection system for injecting a curable recoating material into said mold cavity; and
a curing system for curing said curable recoating material injected into said mold cavity,
characterized in
that said injection system comprises a container (51) for the curable recoating material, a peristaltic or dispenser-based pump (52) preferably driven by any of a DC motor, a servo motor, and a stepping motor, particularly geared, and a tubing system (53) for transporting the UV curable recoating material from the container to the mold blocks, and an injection needle (54) mounted within one of the mold blocks and through which the curable recoating material is brought, wherein
the pump is adapted to transport the UV curable recoating material at a first velocity during a first part of said injection, and at a second velocity during a latter part of said injection, said second velocity being substantially lower than said first velocity.

40. The apparatus as claimed in claim 39 wherein said curing system is a UV curing system and said injection needle, at least adjacent to said mold cavity, is opaque to said UV light.

41. The apparatus as claimed in claim 36 wherein said slide surfaces are surfaces of said second mold block.

42. The apparatus as claimed in claim 36 or 41 wherein said stretchers and said slide surfaces are arranged along the longitudinal axis of the mold cavity, one stretcher and one slide surface on each side of the mold cavity.

43. The apparatus as claimed in any of claims 36, 41 or 42 wherein said apparatus comprises a pair of fiber holders (31a, 31b) for holding coated lengths of said optical fibers in alignment with the longitudinal axis of said mold cavity.

44. The apparatus as claimed in claim 43 wherein said fiber holder comprises a pair of vacuum chucks (31a, 31b) arranged on either side of the mold blocks, each of which vacuum chucks includes a groove extending parallel with the longitudinal axis of the mold cavity and being connectable to a vacuum ejector (35) for supplying vacuum to the vacuum chuck grooves.

45. The apparatus as claimed in any of claims 36 or 41-44 wherein said apparatus comprises a pair of alignment grooves (33a, 33b) for guiding coated lengths of said optical fibers in alignment with the longitudinal axis of said mold cavity while said coated lengths of said optical fibers are inserted into said one of said longitudinally extending grooves.

46. The apparatus as claimed in claim 45 wherein said pair of alignment grooves is formed in said second mold block.

47. The apparatus as claimed in claim 45 or 46 wherein said pair of alignment grooves include each a bottom portion having a square cross section and a top portion having a width larger than the width of the bottom portion for easy reception of the fiber end portions.

48. The apparatus as claimed in claim 47 wherein the bottom portion of each of said alignment grooves has a semicircular cross section.

49. The apparatus as claimed in claim 38 wherein said double acting pivotable clamping unit includes a cylinder (42), a piston (41), and a lever (43), the cylinder being mounted on a base plate together with the first mold block, the piston being vertically movable in the cylinder, the lever being firmly mounted on an upper end of the piston and extending horizontally, the second mold block being mounted at an end of the lever, and the piston and the cylinder being provided with engagable grooves such that the piston is forced to rotated during vertical movement thereof.

50. The apparatus as claimed in claim 37, 38 or 49 wherein the pivotable clamping unit delivers a contact pressure between the first and second mold blocks of at least 0.44 MPa in the closed state.

51. The apparatus as claimed in any of claims 37, 38, 49 or 50 wherein said second mold block is attached to the clamping unit such that said second mold block is pivotably movable around a pivot axis being parallel with the longitudinally extending groove thereof.

52. The apparatus as claimed in claim 51 wherein said pivotably movable attachment is spring biased.

53. The apparatus as claimed in claim 39 wherein the pump is adapted to pump in a reverse direction, i.e. backwards toward the container, during a final part of said injection.

54. The apparatus as claimed in any of claims 39, 40 or 53 wherein the pump is a peristaltic pump.

55. The apparatus as claimed in any of claims 39, 40 or 53 wherein the pump is a positive displacement rod valve.

56. The apparatus as claimed in any of claims 39, 40 or 53-55 wherein the tubing system includes a valve for controlling the amount of curable recoating material brought through said injection needle.
